(19) United States
(12) Patent Application Publication
(10) Pub. No.: US 2024/0314856 A1
(43) Pub. Date: Sep. 19, 2024

(54) METHOD FOR REDUCING SIGNAL INTERFERENCE AND RELATED PRODUCTS

(71) Applicant: SPREADTRUM COMMUNICATIONS (SHANGHAI) CO., LTD., Shanghai (CN)

(72) Inventors: Wendi GU, Shanghai (CN); Hongxu FENG, Shanghai (CN); Cai LI, Shanghai (CN); Yantao LI, Shanghai (CN)

(21) Appl. No.: 18/575,387

(22) PCT Filed: Sep. 23, 2021
(86) PCT No.: PCT/CN2021/119897

§ 371 Date: Dec. 29, 2023

(30) Foreign Application Priority Data
Jun. 30, 2021 (CN) 202110747051.0

(51) Int. Cl. H04W 76/10; H04W 52/24; H04W 84/12

(52) U.S. Cl. CPC H04W 76/10; H04W 52/243; H04W 84/12

(57) ABSTRACT

A method for reducing signal interference and related products are provided. The method is applied to a wireless fidelity (Wi-Fi) circuitry of an electronic device. The method includes the following. Send session establishment request information to a new radio (NR) circuitry. Receive session establishment response information from the NR circuitry. Set a working state of the Wi-Fi circuitry to a first state if it is determined, according to the session establishment response information, that there is signal interference between the Wi-Fi circuitry and the NR circuitry, and a current state of the NR circuitry is an idle state. Adjust the working state of the Wi-Fi circuitry to a second state from the first state if there is still signal interference between the Wi-Fi circuitry and the NR circuitry and the current state of the NR circuitry is a connected state.

### CROSS-REFERENCE TO RELATED APPLICATION(S)

This application is a National Stage of International Application No. PCT/CN2021/119897, field Sep. 23, 2021, which claims priority to Chinese Patent Application No. 2021107470510, filed Jun. 30, 2021, the entire disclosures of which are hereby incorporated by reference.

### TECHNICAL FIELD

The disclosure relates to the field of communication technology, and more particularly, to a method for reducing signal interference and related products.

### BACKGROUND

Modern advanced wireless devices perform data transmission and reception based on multiple radio access technologies. For example, a mobile phone supporting new radio (NR) uses an NR technology and abase station to ensure indoor and outdoor data transmission with low delay, wide coverage, and high bandwidth, and also uses a wireless fidelity (Wi-Fi) circuitry supporting institute of electrical and electronics engineers (IEEE) 802.11ac to realize convenient and inexpensive high-speed Internet access with aid of an indoor broadband. When an NR circuitry and a Wi-Fi circuitry are working in an overlapping frequency band or adjacent frequency bands at the same time, it will result in radio frequency (RF) interference, thus degrading RF performance of the NR circuitry and the Wi-Fi circuitry. In particular, if an electronic device resides in an NR N79 frequency band (for example, 4942.02 megahertz (MHz)) and is connected to a Wi-Fi 5 gigahertz (GHz) channel (for example, 5180 MHz), RF performance of NR and Wi-Fi will be greatly degraded. For example, when the NR circuitry is performing uplink transmission, it will result in desense (that is, degradation of sensitivity) in Wi-Fi side by more than 40 decibels (db), and even result in disconnection. Such a phenomenon of mutual interference will lead to poor user experience.

### SUMMARY

A method for reducing signal interference and related products are provided, so as to reduce mutual interference when using a new radio (NR) circuitry and a wireless fidelity (Wi-Fi) circuitry at the same time, thereby improving user experience.

In a first aspect, a method for reducing signal interference is provided in embodiments of the disclosure. The method is applied to a Wi-Fi circuitry of an electronic device. The method includes the following. Send session establishment request information to an NR circuitry. Receive session establishment response information from the NR circuitry. Set a working state of the Wi-Fi circuitry to a first state if it is determined, according to the session establishment response information, that there is signal interference between the Wi-Fi circuitry and the NR circuitry, and a current state of the NR circuitry is an idle state, where the first state is used for indicating a signal transmission and reception mode of the Wi-Fi circuitry. Adjust the working state of the Wi-Fi circuitry to a second state from the first state if there is still signal interference between the Wi-Fi circuitry and the NR circuitry and the current state of the NR circuitry is a connected state, where the second state is used for indicating a signal transmission and reception mode of the Wi-Fi circuitry.

In a second aspect, a method for reducing signal interference is provided in embodiments of the disclosure. The method is applied to an NR circuitry of an electronic device. The method includes the following. Obtain session establishment request information from a Wi-Fi circuitry. Send session establishment response information.

In a third aspect, an electronic device is provided in embodiments of the disclosure. The electronic device includes a processor, a memory, a communication interface, and one or more programs. The one or more programs are stored in the memory and configured to be executed by the processor. The programs include instructions for implementing steps in the method in any of the first aspect or the second aspect of embodiments of the disclosure.

### BRIEF DESCRIPTION OF THE DRAWINGS

In order to describe more clearly technical solutions of embodiments of the disclosure or the related art, the following will give a brief introduction to the accompanying drawings used for describing the embodiments or the related art. Apparently, the accompanying drawings described below are merely some embodiments of the disclosure. Based on these drawings, those of ordinary skill in the art can also obtain other drawings without creative effort.

FIG. 1a is a schematic diagram illustrating a principle of interference of a new radio (NR) circuitry on a wireless fidelity (Wi-Fi) circuitry provided in embodiments of the disclosure.

FIG. 1b is a schematic diagram illustrating a principle of interference of a Wi-Fi circuitry on an NR circuitry provided in embodiments of the disclosure.

FIG. 2a is a schematic diagram of a communication system provided in embodiments of the disclosure.

FIG. 2b is an architectural diagram of a Wi-Fi circuitry and an NR circuitry provided in embodiments of the disclosure.

FIG. 2c is a schematic structural diagram of an electronic device provided in embodiments of the disclosure.

FIG. 3a is a schematic flowchart of a method for reducing signal interference provided in embodiments of the disclosure.

FIG. 3b is a diagram illustrating a timing of a second working state provided in embodiments of the disclosure.

FIG. 4 is a block diagram illustrating functional units of an apparatus for reducing signal interference provided in embodiments of the disclosure.

FIG. 5 is a block diagram illustrating functional units of another apparatus for reducing signal interference provided in embodiments of the disclosure.

FIG. 6 is a block diagram illustrating functional units of another apparatus for reducing signal interference provided in embodiments of the disclosure.

FIG. 7 is a block diagram illustrating functional units of another apparatus for reducing signal interference provided in embodiments of the disclosure.

### DETAILED DESCRIPTION

In order for those skilled in the art to better understand solutions of the disclosure, the following will describe clearly and comprehensively technical solutions of embodiments of the disclosure with reference to the accompanying drawings in the embodiments of the disclosure. Apparently, embodiments described herein are some embodiments, rather than all embodiments, of the disclosure. Based on the embodiments of the disclosure, all other embodiments obtained by those of ordinary skill in the art without creative effort shall fall within the protection scope of the disclosure.

The terms “first”, “second”, etc. in the specification and claims of the disclosure and in the accompanying drawings are intended for distinguishing different objects rather than describing a particular order. In addition, the terms “include”, “comprise”, and “have” as well as variations thereof are intended to cover non-exclusive inclusion. For example, a process, method, system, product, or device including a series of steps or units is not limited to the listed steps or units, instead, it may optionally include other steps or units that are not listed, or may optionally include other steps or units inherent to the process, method, product, or device.

The term “embodiment” referred to herein means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments. In the embodiments of the disclosure, the terms “system” and “network” are often used interchangeably, but the meaning thereof can be understood by those skilled in the art.

Firstly, some terms involved in the embodiments of the disclosure are explained to facilitate understanding by those skilled in the art.

1. Electronic device (user equipment (UE)). The electronic device in the embodiments of the disclosure is a device having a wireless transceiver function, and may be referred to as a terminal, a terminal device, a mobile station (MS), a mobile terminal (MT), an access terminal device, an in-vehicle terminal device, an terminal device in industrial control, a UE unit, a UE station, a mobile station, a remote station, a remote terminal device, a mobile device, a UE terminal device, a wireless communication device, a UE agent, or a UE apparatus. The electronic device may be stationary or mobile. It should be noted that, the electronic device may support at least one wireless communication technology, such as long-term evolution (LTE), new radio (NR), and wideband code division multiple access (WCDMA). For example, the electronic device may be a mobile phone, a pad, a desktop computer, a notebook computer, an all-in-one computer, an in-vehicle terminal, a virtual reality (VR) terminal device, an augmented reality (AR) terminal device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) phone, a wireless local loop (WLL) station, a personal digital assistant (PDA), a handheld device or a computing device having a wireless communication function or other processing devices connected to a wireless modem, a wearable device, a terminal device in a future mobile communication network, or a terminal device in a future evolved public land mobile network (PLMN). In some embodiments of the disclosure, the electronic device may also be an apparatus with a transceiver function, for example, a system-on-chip (SOC). The SOC may include a chip, and may further include other discrete components.

2. Discontinuous reception (DRX): in this mode, a UE can enter a sleep mode periodically at some times, where in the sleep mode, the UE does not monitor a physical downlink control channel (PDCCH) subframe; and if monitoring is needed, the UE can wake up from the sleep mode.

3. NR: a global 5th-generation (5G) standard designed based on an orthogonal frequency division multiplexing (OFDM)-based new air interface, which is also an important basis of a next-generation cellular mobile technology. With a 5G technology, it is possible to realize ultra-low delay and high reliability. NR relates to an OFDM-based NR standard. OFDM refers to a digital multi-carrier modulation technique. With adoption of this standard by 3rd-generation partnership project (3GPP), the term “NR” is used, thereby becoming another name of 5G.

The following will describe technical solutions of embodiments of the disclosure with reference to the accompanying drawings.

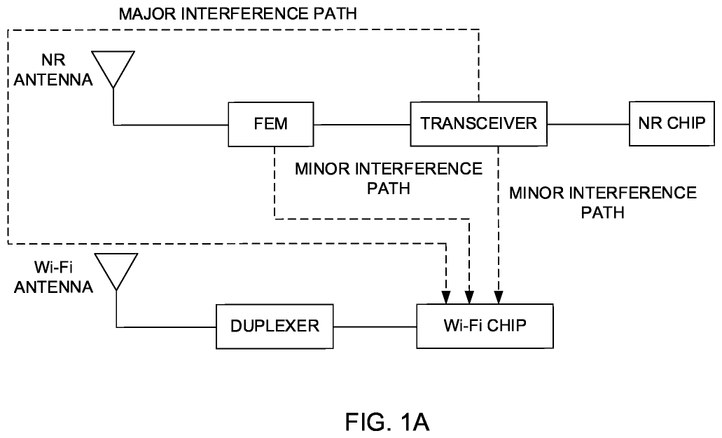

Referring to FIG. 1a, FIG. 1a is a schematic diagram illustrating a principle of interference of an NR circuitry on a wireless fidelity (Wi-Fi) circuitry provided in embodiments of the disclosure. As illustrated in the figure, a major interference path is that: an NR radio frequency (RF) signal transmitted from an RF transceiver is radiated from an NR antenna after being amplified by a front-end module (FEM), then is received by a Wi-Fi antenna, and then reaches a Wi-Fi chip through a duplexer, thus interfering with a Wi-Fi receiving module and affecting receive (Rx) performance of the Wi-Fi receiving module. A minor interference path is that: an NR RF signal radiated from an NR chip port or an FEM port directly enters the Wi-Fi chip through spatial coupling, thus interfering with the Wi-Fi circuitry.

Referring to FIG. 1b, FIG. 1b is a schematic diagram illustrating a principle of interference of a Wi-Fi circuitry on an NR circuitry provided in embodiments of the disclosure. As illustrated in the figure, a major interference path is that: a Wi-Fi RF signal transmitted from a Wi-Fi chip is radiated from a Wi-Fi antenna after passing through a berkeley packet filter (BPF) and a duplexer, then is received by an NR antenna, and then reaches a transceiver chip through an FEM, thus interfering with an NR receiving circuitry and affecting Rx performance of the NR receiving circuitry. A minor interference path is that: a Wi-Fi RF signal radiated from a Wi-Fi chip port directly enters the transceiver chip through spatial coupling, thus interfering with the NR circuitry.

In view of the above problems, embodiments of the disclosure provide a method for reducing signal interference and related products. The following will describe technical solutions of embodiments of the disclosure with reference to the accompanying drawings.

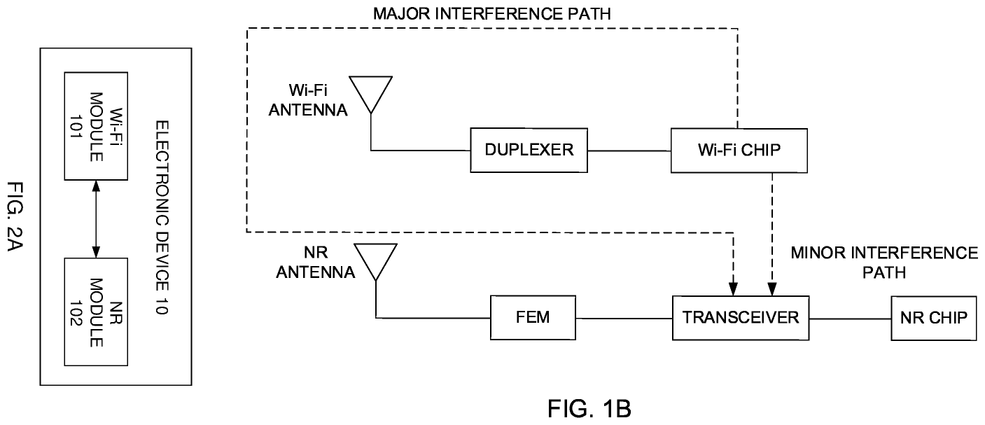

Referring to FIG. 2a, FIG. 2a is a schematic diagram of a communication system provided in embodiments of the disclosure. As illustrated in FIG. 2a, an electronic device 10 includes a Wi-Fi circuitry 101 and an NR circuitry 102. The Wi-Fi circuitry 101 is configured for the electronic device to communicate through Wi-Fi. The NR circuitry 102 is configured for the electronic device to communicate through 5G. The Wi-Fi circuitry 101 includes a Wi-Fi chip. The NR circuitry 102 includes a 5G chip. As illustrated in FIG. 2b, FIG. 2b is an architectural diagram of a Wi-Fi circuitry and an NR circuitry provided in embodiments of the disclosure. The NR circuitry and the Wi-Fi circuitry each include an Inter mobile wireless system (MWS) interface. The NR circuitry and the Wi-Fi circuitry can perform cross-core information interaction via the Inter MWS interfaces to transfer information of their respective wireless systems, which includes a frequency point, a bandwidth, a downlink power, a working state, and a frame time-domain configuration, etc. of NR, and a channel, a received signal strength, etc. of Wi-Fi.

Referring to FIG. 2c, FIG. 2c is a schematic structural diagram of an electronic device provided in embodiments of the disclosure. As illustrated in the figure, the electronic device illustrated in FIG. 2a may be structured as follows. The electronic device 20 includes a processor 210, a memory 220, a communication interface 230, and one or more programs 221. The one or more programs 221 are stored in the memory 220 and configured to be executed by the processor 210. The programs 221 include operations implemented by a device at a UE-side in the method described in the method embodiments of the disclosure.

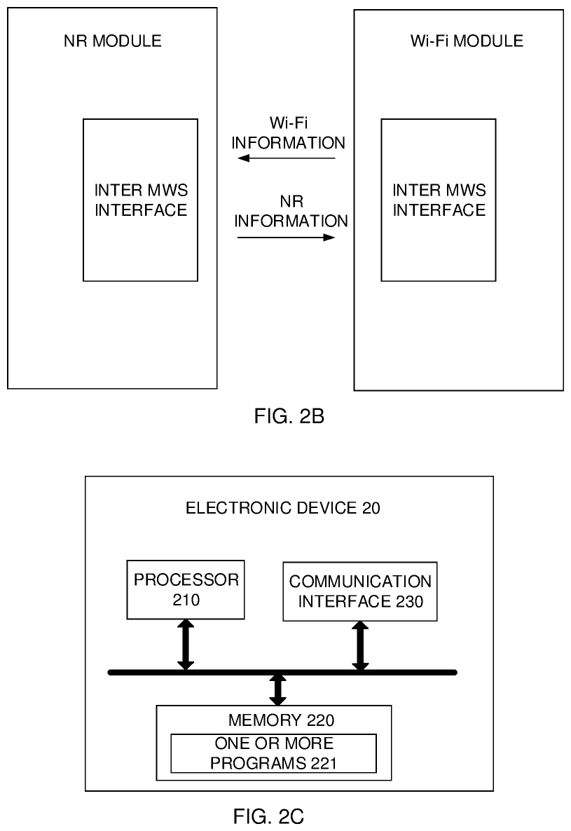

Referring to FIG. 3a, FIG. 3a is a schematic flowchart of a method for reducing signal interference provided in embodiments of the disclosure. As illustrated in the figure, the method includes the following.

Step 301, a Wi-Fi circuitry sends session establishment request information to an NR circuitry.

Step 302, receive session establishment response information from the NR circuitry.

After being enabled and connected to a 5 gigahertz (GHz) channel, the Wi-Fi circuitry will start to send repeatedly the session establishment request information to the NR circuitry via an Inter MWS interface. After receiving the session establishment request information, the NR circuitry will reply the session establishment response information, and only in this case will the Wi-Fi circuitry stop sending the information. The session establishment request information may include band request information to the NR circuitry, so as to request band-related information of the NR. The session establishment response information replied by the NR circuitry may include information such as a band identity (ID) of the NR, bandwidth information of the NR, a sub-band ID of a certain piece of content of the NR, and a signal strength of a serving cell of the NR.

Step 303, set a working state of the Wi-Fi circuitry to a first state, if it is determined, according to the session establishment response information, that there is signal interference between the Wi-Fi circuitry and the NR circuitry, and a current state of the NR circuitry is an idle state.

The first state is used for indicating a signal transmission and reception mode of the Wi-Fi circuitry. The Wi-Fi circuitry and the NR circuitry may start to exchange band information after a message session is established via their Inter MWS interfaces. The Wi-Fi circuitry may determine, according to the band information received, whether there is interference in a frequency band(s) currently used by the NR circuitry and Wi-Fi circuitry. In addition, the Wi-Fi circuitry may obtain the current state of the NR circuitry, that is, whether the NR circuitry is in an idle state or is in a connected state. If the NR circuitry is currently in an idle state, the Wi-Fi circuitry will set the working state of the Wi-Fi circuitry to the first state. In this way, it is possible to reduce desense of the Wi-Fi circuitry and the NR circuitry during working when the Wi-Fi circuitry and the NR circuitry are working at the same time, thereby improving user experience.

Step 304, adjust the working state of the Wi-Fi circuitry to a second state from the first state, if there is still signal interference between the Wi-Fi circuitry and the NR circuitry and the current state of the NR circuitry is a connected state, where the second state is used for indicating a signal transmission and reception mode of the Wi-Fi circuitry.

If the working state of the Wi-Fi circuitry is adjusted to the first state, the Wi-Fi circuitry will exchange band information with the NR circuitry, and determine whether there is still signal interference between the Wi-Fi circuitry and the NR circuitry. If there is still signal interference and the current state of the NR circuitry is changed to a connected state, the Wi-Fi circuitry will adjust the working state of the Wi-Fi circuitry to the second state from the first state. In this case, the Wi-Fi circuitry adjusts the working state according to the current state of the NR circuitry. As such, it is possible to reduce desense of the Wi-Fi circuitry and the NR circuitry during working when the Wi-Fi circuitry and the NR circuitry are working at the same time, thereby improving user experience.

As can be seen, in the embodiments, the Wi-Fi circuitry sends the session establishment request information to the NR circuitry, and then receives the session establishment response information from the NR circuitry. If it is determined, according to the session establishment response information, that there is signal interference between the Wi-Fi circuitry and the NR circuitry, and the current state of the NR circuitry is an idle state, the working state of the Wi-Fi circuitry will be set to the first state, where the first state is used for indicating a signal transmission and reception mode of the Wi-Fi circuitry. If there is still signal interference between the Wi-Fi circuitry and the NR circuitry and the current state of the NR circuitry is a connected state, the working state of the Wi-Fi circuitry will be adjusted to the second state from the first state, where the second state is used for indicating a signal transmission and reception mode of the Wi-Fi circuitry. In this way, the Wi-Fi circuitry can adjust promptly the working state according to the current state of the NR circuitry, thereby reducing signal interference when the Wi-Fi circuitry and the NR circuitry are working at the same time, and thus improving user experience.

In a possible embodiment, the working state of the Wi-Fi circuitry is set to the first state as follows. Determine whether the NR circuitry has started random access. In case the NR circuitry has started random access, the Wi-Fi circuitry stops signal transmission and reception. In case the NR circuitry has not started random access, the Wi-Fi circuitry performs signal transmission and reception and executes a first strategy.

If the working state of the Wi-Fi circuitry is the first state, determine whether the NR circuitry has started random access. If the NR circuitry has started random access, the Wi-Fi circuitry stops signal transmission and reception, and in this case, only the NR circuitry performs signal transmission and reception. If the NR circuitry does not perform random operations, the first strategy will be executed.

As can be seen, in the embodiments, by adjusting the signal transmission and reception mode of the Wi-Fi circuitry according to the current state of the NR circuitry, it is possible to reduce signal interference when the Wi-Fi circuitry and the NR circuitry are working at the same time, thereby improving user experience.

In a possible embodiment, the first strategy is executed as follows. Determine a downlink power of the NR circuitry. Determine a power back-off level according to the downlink power.

Perform power back-off according to the power back-off level, to reduce a transmit power of the Wi-Fi circuitry.

If the Wi-Fi circuitry works in the first state and the NR circuitry does not perform random access, the Wi-Fi circuitry may perform signal transmission and reception. In this case, when performing signal transmission and reception, the Wi-Fi circuitry firstly determines the downlink power of the NR circuitry, and then performs power back-off according to the downlink power, so that the transmit power of the Wi-Fi circuitry is reduced, thereby reducing influence on signal reception of the NR circuitry. If the downlink power of the NR circuitry changes, the Wi-Fi circuitry dynamically adjusts a magnitude by which the transmit power of the Wi-Fi circuitry is to be reduced, that is, adjusts the power back-off level.

As can be seen, in the embodiments, by reducing the transmit power of the Wi-Fi circuitry during signal transmission and reception of the Wi-Fi circuitry, it is possible to reduce desense of the Wi-Fi circuitry and the NR circuitry during working when the Wi-Fi circuitry and the NR circuitry are working at the same time, thereby improving user experience.

In a possible embodiment, the power back-off level includes three levels, which include 6 decibels (dB) back-off, 12 dB back-off, and 18 dB back-off.

The back-off level is set to have three levels, and a current back-off level is determined according to the downlink power of the NR circuitry. If the downlink power of the NR circuitry falls within a certain range, the back-off level will be determined, and the transmit power of the Wi-Fi circuitry will be backed off according to the corresponding level. Multiple other back-off levels can also be determined according to different downlink power ranges.

As can be seen, in the embodiments, the back-off level is determined according to a downlink power range of the NR circuitry, so as to reduce the transmit power of the Wi-Fi circuitry. As such, it is possible to reduce desense of the Wi-Fi circuitry and the NR circuitry during working when the Wi-Fi circuitry and the NR circuitry are working at the same time, thereby improving user experience.

In a possible embodiment, the working state of the Wi-Fi circuitry is set to the first state as follows. If the NR circuitry is receiving a system information block (SIB), the Wi-Fi circuitry stops signal transmission and reception.

When the working state of the Wi-Fi circuitry is the first state and the current state of the NR circuitry is an idle state, if the NR circuitry is receiving an SIB, the Wi-Fi circuitry stops signal transmission and reception. In this case, the Wi-Fi circuitry may have executed the first strategy, or may have not executed the first strategy.

As can be seen, in the embodiments, if the NR circuitry is receiving an SIB, the Wi-Fi circuitry stops signal transmission and reception, which can ensure a signal received quality of the NR circuitry, thereby improving user experience.

In a possible embodiment, if the NR circuitry is DRX-enabled, the working state of the Wi-Fi circuitry is set to the first state as follows. If the NR circuitry is not receiving channel information, the Wi-Fi circuitry performs signal transmission and reception. If the NR circuitry is receiving channel information, the Wi-Fi circuitry stops signal transmission and reception.

In DRX, an electronic device can enter a sleep mode periodically at some times, where in the sleep mode, the electronic device does not monitor a PDCCH subframe; and if monitoring is needed, the electronic device can wake up from the sleep mode, thereby realizing power saving of the electronic device. When the working state of the Wi-Fi circuitry is the first state and the NR circuitry is enabled for DRX, if the NR circuitry is receiving channel information, the Wi-Fi circuitry will not perform signal transmission and reception; and if the NR circuitry is not receiving channel information, the Wi-Fi circuitry can perform signal transmission and reception.

As can be seen, in the embodiments, if the NR circuitry is DRX-enabled, whether the Wi-Fi circuitry is to perform signal transmission and reception is determined according to whether the NR circuitry is receiving channel information, which can ensure that the NR circuitry receives channel information quickly and completely, thereby improving user experience.

In a possible embodiment, the working state of the Wi-Fi circuitry is adjusted to the second state from the first state as follows. Obtain a DRX state of the NR circuitry. Execute a second strategy if the DRX state is a wake-up state. Execute a third strategy if the DRX state is a sleep state.

In DRX, it is in the wake-up state when performing channel monitoring, and is in the sleep state when not performing channel monitoring. After adjusting the working state to the second state from the first state, the Wi-Fi circuitry will obtain the DRX state of the NR circuitry, and determine a signal transmission and reception strategy according to the DRX state. If the DRX state of the NR circuitry is the wake-up state, since the NR circuitry is performing channel monitoring, the Wi-Fi circuitry will execute the second strategy, that is, determine a time period for signal transmission and reception of the Wi-Fi circuitry according to a time period for signal transmission and reception of the NR circuitry, so as to reduce interference on channel message reception of the NR circuitry when the Wi-Fi circuitry is performing signal transmission and reception. If the DRX state of the NR circuitry is the sleep state, the NR circuitry is not performing channel monitoring, and therefore, the Wi-Fi circuitry can perform signal transmission and reception at any time in this time period, that is, the Wi-Fi circuitry executes the third strategy in this case, and the time period for signal transmission and reception of the Wi-Fi circuitry is not up to the NR circuitry. However, if the DRX state changed to the wake-up state from the sleep state, the working state of the Wi-Fi circuitry will be adjusted to executing the second strategy from executing the third strategy.

As can be seen, in the embodiments, the Wi-Fi circuitry determines a current signal transmission and reception strategy according to the DRX state. As such, it is possible to reduce desense of the Wi-Fi circuitry and the NR circuitry during working when the Wi-Fi circuitry and the NR circuitry are working at the same time, thereby improving user experience.

In a possible embodiment, before adjusting the working state of the Wi-Fi circuitry to the second state from the first state, the method further includes the following. Send slot pattern request information to the NR circuitry. Receive slot pattern response information from the NR circuitry.

Determine a time domain corresponding to a downlink subframe and a special subframe according to the slot pattern response information.

The Wi-Fi circuitry may send the slot pattern request information to the NR circuitry, and the NR circuitry can send corresponding slot pattern information to the Wi-Fi circuitry, so that the Wi-Fi circuitry determines a time period for signal transmission and reception according to the slot pattern obtained, which can ensure that a signal corresponding to the Wi-Fi circuitry is transmitted and received in a specific time period, so as to reduce influence on signal reception of the NR circuitry when the Wi-Fi circuitry is performing signal transmission and reception. Specifically, the transmission mode may be periodic repetitions.

During implementation, the slot pattern information may include time domain configuration information of a current NR cell, relative delay information of a next frame for NR, etc. In addition, when replying to the Wi-Fi circuitry, status information of the NR terminal may also be included, for example, whether to synchronize, whether it is performing a voice operation, whether it is in C-DRX in a connected state or is in I-DRX in an idle state. The NR circuitry may also send frequency request information to the Wi-Fi circuitry via an Inter MWS interface, so as to obtain content such as a transmitted signal strength and a Wi-Fi channel ID of the Wi-Fi circuitry, where the transmission mode may be periodic repetitions. Specifically, the NR circuitry may also send repeatedly timing advance information to the Wi-Fi circuitry periodically, so that the NR circuitry and the Wi-Fi circuitry remain synchronized.

As can be seen, in the embodiments, the Wi-Fi circuitry determines a time period for signal transmission and reception according to a slot for the NR circuitry. As such, it is possible to reduce desense of the Wi-Fi circuitry and the NR circuitry during working when the Wi-Fi circuitry and the NR circuitry are working at the same time, thereby improving user experience.

In a possible embodiment, the second strategy includes the following. Perform transmission and reception in the time domain corresponding to the downlink subframe and the special subframe.

The slot pattern information includes a time period corresponding to each of an uplink subframe, a downlink subframe, and a special subframe. The NR circuitry sends information only over some of uplink symbols corresponding to an uplink subframe and a special subframe, such that a transmission time period of the Wi-Fi circuitry is staggered with a transmission time period of the NR circuitry, which can reduce influence caused by signal interference between the Wi-Fi circuitry and the NR circuitry. For example, as illustrated in FIG. 3b, FIG. 3b is diagram illustrating a timing of the second working state provided in embodiments of the disclosure. As can be seen, a slot pattern configuration illustrated in the figure is “DSUUU”, where “D” represents a downlink subframe, “S” represents a special subframe, and “U” represents an uplink subframe. The Wi-Fi circuitry performs transmission and reception in a time domain (1 millisecond (ms) in total) corresponding to a downlink subframe and a special subframe for the NR circuitry every two periods (2*2.5 ms).

As can be seen, in the embodiments, by ensuring that the Wi-Fi circuitry performs signal transmission and reception in a time period corresponding to a downlink subframe and a special subframe in a slot pattern corresponding to the NR circuitry, it is possible to reduce influence caused by signal interference between the Wi-Fi circuitry and the NR circuitry, thereby improving user experience.

In a possible embodiment, when performing transmission and reception in the time domain corresponding to the downlink subframe and the special subframe, the method further includes the following. Reduce the transmit power of the Wi-Fi circuitry.

Since the NR circuitry may perform signal transmission in a time period corresponding to a special subframe, when the Wi-Fi circuitry and the NR circuitry are performing signal transmission and reception at the same time in the special subframe, the NR circuitry will reduce a transmit power, so as to reduce interference of the NR circuitry on signal reception of the Wi-Fi circuitry, where the scheme for reducing the transmit power may be that the NR circuitry performs power back-off. As illustrated in FIG. 3b, signal transmission of the NR circuitry overlaps signal transmission of the Wi-Fi circuitry in the special subframe, and therefore, the NR circuitry needs to perform power back-off during transmission. Since the special subframe includes an uplink symbol, NR needs to reduce a power on the uplink symbol in the uplink subframe, so as to reduce interference on reception of the Wi-Fi circuitry. That is, during a period in which the Wi-Fi circuitry performs signal transmission and reception, the NR circuitry needs to perform power back-off when performing signal transmission; and during a period in which the Wi-Fi circuitry does not perform signal transmission and reception, the NR circuitry does not need to perform power back-off when performing signal transmission.

In a possible embodiment, after sending the session establishment response, the method further includes the following. The NR circuitry sends frequency request information to the Wi-Fi circuitry, and obtains frequency information from the Wi-Fi circuitry. If it is determined, according to the frequency information, that an operating band of the Wi-Fi circuitry overlaps an operating band of the NR circuitry, a transmit power of the NR circuitry will be reduced.

As can be seen, in the embodiments, the NR circuitry reduces the transmit power when the NR circuitry and the Wi-Fi circuitry are performing signal transmission and reception at the same time. As such, it is possible to reduce interference of the NR circuitry on signal reception of the Wi-Fi circuitry, thereby improving user experience.

In a possible embodiment, after executing the second strategy or executing the third strategy, the method further includes the following. Obtain a current service of the NR circuitry. If the current service is a voice service, the Wi-Fi circuitry stops signal transmission and reception.

When obtaining band information of the NR circuitry, the Wi-Fi circuitry may also obtain a service status of the NR circuitry. If the current service of the NR circuitry is a voice service, the Wi-Fi circuitry will stop signal transmission and reception.

As can be seen, in the embodiments, if the current service of the NR circuitry is a voice service, the Wi-Fi circuitry stops signal transmission and reception, which is possible to ensure normal operation of a voice service of the electronic device, thereby improving user experience.

In a possible embodiment, after adjusting the working state of the Wi-Fi circuitry to the second state from the first state, the method further includes the following. Obtain a current state of the NR circuitry. If the current state is an idle state, adjust the working state to the first state from the second state.

The Wi-Fi circuitry and the NR circuitry may perform information exchange frequently.

The Wi-Fi circuitry can obtain the current state of the NR circuitry in real time, periodically, or repeatedly, and then adjust the working state of the Wi-Fi circuitry according to the current state of the NR circuitry. If the current working state of the Wi-Fi circuitry is the second state and the current state of the NR circuitry is adjusted to the idle state, the Wi-Fi circuitry will leave the second state and adjust the current working state to the first state, so as to reduce signal interference when the NR circuitry and the Wi-Fi circuitry are working at the same time.

As can be seen, in the embodiments, by adjusting promptly the working state of the Wi-Fi circuitry according to the current state of an NR circuitry, it is possible to reduce desense of the Wi-Fi circuitry and the NR circuitry during working when the Wi-Fi circuitry and the NR circuitry are working at the same time, thereby improving user experience.

In a possible embodiment, after setting the working state of the Wi-Fi circuitry to the first state or adjusting the working state to the second state from the first state, the method further includes the following. Obtain band information of each of the Wi-Fi circuitry and the NR circuitry. Adjust the working state of the Wi-Fi circuitry to a third state from the first state or the second state if it is determined, according to the band information, that there is no interference between a Wi-Fi signal and an NR signal, or adjust the working state of the Wi-Fi circuitry to the third state from the first state or the second state after the Wi-Fi circuitry is disconnected.

When the working state of the Wi-Fi circuitry is the first state or the second state, if a frequency band combination of the Wi-Fi circuitry and the NR circuitry is updated, that is, there is no signal interference between the Wi-Fi circuitry and the NR circuitry, the working state of the Wi-Fi circuitry will be adjusted to the third state. In the third state, the Wi-Fi circuitry can perform signal transmission and reception as usual, and does not have to reduce the transmit power nor perform signal transmission and reception only in a time period corresponding to a downlink subframe and a special subframe for the NR circuitry. Alternatively, after the Wi-Fi circuitry is disconnected, the working state of the Wi-Fi circuitry will also be adjusted to the third state. In this case, when the Wi-Fi circuitry is in the third state, if the Wi-Fi circuitry is enabled again and connected to a 5 GHz channel, the Wi-Fi circuitry will send the session establishment request information to an NR side.

As can be seen, in the embodiments, if there is no signal interference between the Wi-Fi circuitry and the NR circuitry or the Wi-Fi circuitry is disconnected, the Wi-Fi circuitry will leave the first state or the second state, which can adjust flexibly the working state of the Wi-Fi circuitry, thereby improving user experience.

Embodiments of the disclosure provide an apparatus for reducing signal interference. The apparatus is configured to implement steps performed by a Wi-Fi circuitry of an electronic device in the foregoing method for reducing signal interference. The apparatus for reducing signal interference provided in embodiments of the disclosure may include units corresponding to the respective steps.

According to embodiments of the disclosure, division of functional modules of an apparatus for reducing signal interference can be exemplarily implemented according to the foregoing method. For example, each functional module may be divided to correspond to each function, or two or more functions may be integrated into one processing module. The integrated module may be implemented in the form of hardware, or may be implemented in the form of software functional module. The division of modules in embodiments of the disclosure is illustrative, and is only a division of logical functions, and other manners of division may be available in practice.

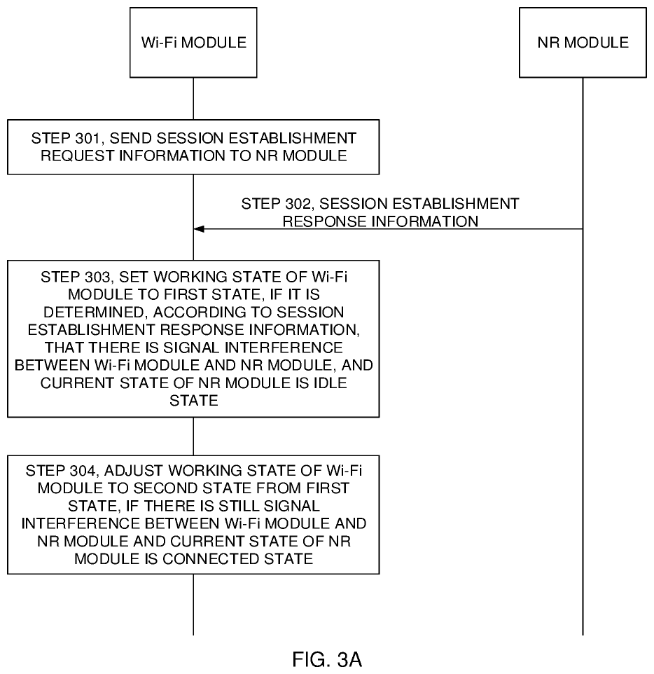

If each functional module is divided to correspond to each function, as illustrated in FIG. 4, FIG. 4 is a block diagram illustrating functional units of an apparatus for reducing signal interference provided in embodiments of the disclosure. The apparatus 40 is applied to a Wi-Fi circuitry of an electronic device. The apparatus 40 includes a sending unit 401, a receiving unit 402, a setting unit 403, and an adjusting unit 404. The sending unit 401 is configured to send session establishment request information to an NR circuitry. The receiving unit 402 is configured to receive session establishment response information from the NR circuitry. The setting unit 403 is configured to set a working state of the Wi-Fi circuitry to a first state if it is determined, according to the session establishment response information, that there is signal interference between the Wi-Fi circuitry and the NR circuitry, and a current state of the NR circuitry is an idle state, where the first state is used for indicating a signal transmission and reception mode of the Wi-Fi circuitry. The adjusting unit 404 is configured to adjust the working state of the Wi-Fi circuitry to a second state from the first state if there is still signal interference between the Wi-Fi circuitry and the NR circuitry and the current state of the NR circuitry is a connected state, where the second state is used for indicating a signal transmission and reception mode of the Wi-Fi circuitry.

In a possible example, in terms of setting the working state of the Wi-Fi circuitry to the first state, the setting unit 403 is specifically configured to: determine whether the NR circuitry has started random access; in case the NR circuitry has started random access, stop signal transmission and reception of the Wi-Fi circuitry; and in case the NR circuitry has not started random access, perform signal transmission and reception of the Wi-Fi circuitry and execute a first strategy.

In a possible example, in terms of executing the first strategy, the setting unit 403 is specifically configured to: determine a downlink power of the NR circuitry, determine a power back-off level according to the downlink power, and perform power back-off according to the power back-off level, to reduce a transmit power of the Wi-Fi circuitry.

In a possible example, the power back-off level includes three levels, which include 6 dB back-off, 12 dB back-off, and 18 dB back-off.

In a possible example, in terms of setting the working state of the Wi-Fi circuitry to the first state, the setting unit 403 is specifically configured to: stop signal transmission and reception of the Wi-Fi circuitry if the NR circuitry is receiving an SIB.

In a possible example, the NR circuitry is DRX-enabled, and in terms of setting the working state of the Wi-Fi circuitry to the first state, the setting unit 403 is specifically configured to: perform signal transmission and reception of the Wi-Fi circuitry if the NR circuitry is not receiving channel information; stop signal transmission and reception of the Wi-Fi circuitry if the NR circuitry is receiving channel information.

In a possible example, in terms of adjusting the working state of the Wi-Fi circuitry to the second state from the first state, the adjusting unit 404 is specifically configured to: obtain a DRX state of the NR circuitry; execute a second strategy if the DRX state is a wake-up state; execute a third strategy if the DRX state is a sleep state.

In a possible example, the apparatus 40 is further configured to operate as follows before adjusting the working state of the Wi-Fi circuitry to the second state from the first state: send slot pattern request information to the NR circuitry, receive slot pattern response information from the NR circuitry, and determine a time domain corresponding to a downlink subframe and a special subframe according to the slot pattern response information.

In a possible example, the second strategy includes: performing transmission and reception in the time domain corresponding to the downlink subframe and the special subframe.

In a possible example, the apparatus 40 is further configured to reduce the transmit power of the Wi-Fi circuitry when performing transmission and reception in the time domain corresponding to the downlink subframe and the special subframe.

In a possible example, the apparatus is further configured to operate as follows after executing the second strategy or executing the third strategy: obtain a current service of the NR circuitry; and stop signal transmission and reception of the Wi-Fi circuitry if the current service is a voice service.

In a possible example, the apparatus is further configured to operate as follows after setting the working state of the Wi-Fi circuitry to the first state or adjusting the working state to the second state from the first state: obtain band information of each of the Wi-Fi circuitry and the NR circuitry; adjust the working state of the Wi-Fi circuitry to a third state from the first state or the second state if it is determined, according to the band information, that there is no interference between a Wi-Fi signal and an NR signal; or adjust the working state of the Wi-Fi circuitry to the third state from the first state or the second state after the Wi-Fi circuitry is disconnected.

All related content of each step involved in the foregoing method embodiments may be incorporated into functional illustration of a corresponding functional unit by reference, which will not be described again herein. The apparatus for reducing signal interference provided in embodiments of the disclosure includes, but is not limited to, the foregoing units. For example, the apparatus for reducing signal interference may further include a storage unit. The storage unit may be configured to store program codes and data of the apparatus for reducing signal interference.

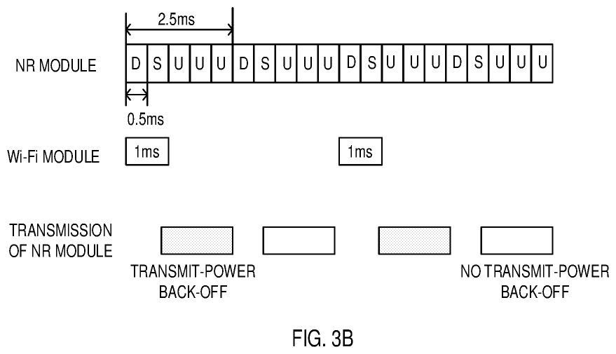

If an integrated unit is adopted, FIG. 5 is a schematic structural diagram of an apparatus for reducing signal interference provided in embodiments of the disclosure. In FIG. 5, the apparatus 5 includes a processing module 50 and a communicating module 51. The processing module 50 is configured to control and manage actions of the apparatus for reducing signal interference, for example, steps implemented by the sending unit 401, the receiving unit 402, the setting unit 403 the adjusting unit 404, and/or other procedures for implementing the technology described herein.

The communicating module 51 is configured to support communication between the apparatus for reducing signal interference and other devices. As illustrated in FIG. 5, the apparatus for reducing signal interference may further include a storage module 52. The storage module 52 is configured to store program codes and data of the apparatus, for example, store content stored in the foregoing storage unit.

The processing module 50 may be a processor or a controller, and may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various illustrative logic blocks, modules, and circuits described in connection with the disclosure can be implemented or executed. The processor may also be a combination for implementing computing functions, for example, a combination that includes one or more microprocessors, a combination of a DSP and a microprocessor, and the like. The communicating module 51 may be a transceiver, an RF circuit, a communication interface, or the like. The storage module 52 may be a memory.

All related content of each scenario involved in the foregoing method embodiments may be incorporated into functional illustration of a corresponding functional module by reference, which will not be described again herein. Both the apparatus 40 for reducing signal interference and the apparatus 5 for reducing signal interference can implement the steps performed by the Wi-Fi circuitry of the electronic device in the foregoing method for reducing signal interference illustrated in FIG. 3a.

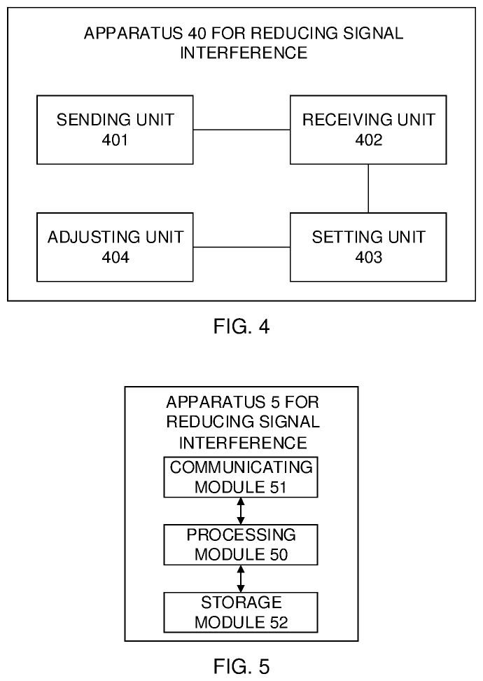

If each functional module is divided to correspond to each function, as illustrated in FIG. 6, FIG. 6 is a block diagram illustrating functional units of another apparatus for reducing signal interference provided in embodiments of the disclosure. The apparatus 60 for reducing signal interference is applied to an NR circuitry of an electronic device. The apparatus 60 includes an obtaining unit 601 and a sending unit 602. The obtaining unit 601 is configured to obtain session establishment request information from a Wi-Fi circuitry. The sending unit 602 is configured to send session establishment response information.

In a possible embodiment, the apparatus 60 is further configured to operate as follows after sending the session establishment response: send frequency request information to the Wi-Fi circuitry, obtain frequency information from the Wi-Fi circuitry, and reduce a transmit power of the NR circuitry if it is determined, according to the frequency information, that an operating band of the Wi-Fi circuitry overlaps an operating band of the NR circuitry.

All related content of each step involved in the foregoing method embodiments may be incorporated into functional illustration of a corresponding functional unit by reference, which will not be described again herein. The apparatus for reducing signal interference provided in embodiments of the disclosure includes, but is not limited to, the foregoing units. For example, the apparatus for reducing signal interference may further include a storage unit. The storage unit may be configured to store program codes and data of the apparatus for reducing signal interference.

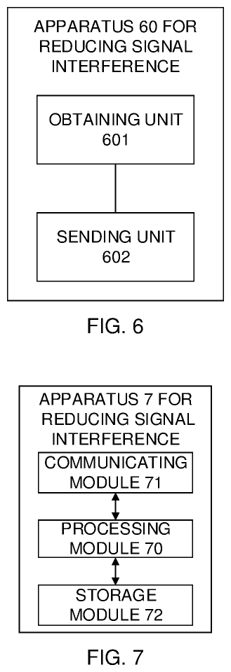

If an integrated unit is adopted, FIG. 7 is a schematic structural diagram of an apparatus for reducing signal interference provided in embodiments of the disclosure. In FIG. 7, the apparatus 7 for reducing signal interference includes a processing module 70 and a communicating module 71.

The processing module 70 is configured to control and manage actions of the apparatus for reducing signal interference, for example, steps implemented by the obtaining unit 601 and the sending unit 602, and/or other procedures for implementing the technology described herein. The communicating module 71 is configured to support communication between the apparatus for reducing signal interference and other devices. As illustrated in FIG. 7, the apparatus for reducing signal interference may further include a storage module 72. The storage module 72 is configured to store program codes and data of the apparatus, for example, store content stored in the foregoing storage unit.

The processing module 70 may be a processor or a controller, and may be, for example, a CPU, a general-purpose processor, a DSP, an ASIC, an FPGA, or other programmable logic devices, transistor logic devices, hardware components, or any combination thereof. Various illustrative logic blocks, modules, and circuits described in connection with the disclosure can be implemented or executed. The processor may also be a combination for implementing computing functions, for example, a combination that includes one or more microprocessors, a combination of a DSP and a microprocessor, and the like. The communicating module 71 may be a transceiver, an RF circuit, a communication interface, or the like. The storage module 72 may be a memory.

All related content of each scenario involved in the foregoing method embodiments may be incorporated into functional illustration of a corresponding functional module by reference, which will not be described again herein. Both the apparatus 60 for reducing signal interference and the apparatus 7 for reducing signal interference can implement the steps performed by the NR circuitry of the electronic device in the foregoing method for reducing signal interference illustrated in FIG. 3a.

Embodiments of the disclosure further provide a chip. The chip includes a processor. The processor is configured to invoke and execute computer programs from a memory, to cause a device equipped with the chip to perform some or all of the steps of a terminal described in the foregoing method embodiments.

Embodiments of the disclosure further provide a chip module. The chip module includes a transceiver component and a chip. The chip includes a processor. The processor is configured to invoke and execute computer programs from a memory, to cause a device equipped with the chip to perform some or all of the steps of the terminal described in the foregoing method embodiments.

Embodiments of the disclosure further provide a computer-readable storage medium. The computer-readable storage medium is configured to store computer programs for electronic data interchange (EDI). The computer programs are operable with a computer to perform some or all of the steps of a network-side device described in the foregoing method embodiments.

Embodiments of the disclosure further provide a computer program product. The computer program product includes computer programs. The computer programs are operable with a computer to perform some or all of the steps of a terminal described in the foregoing method embodiments. The computer program product may be a software installation package.

The steps of the method or algorithm described in embodiments of the disclosure may be implemented by means of hardware, or may be implemented by means of software instructions executed by a processor. The software instructions may consist of corresponding software modules, and the software modules may be stored in a random access memory (RAM), a flash memory, a read only memory (ROM), an erasable programmable ROM (EPROM), an electrically EPROM (EEPROM), a register, a hard disk, a mobile hard disk, a compact disk-ROM (CD-ROM), or any other form of storage medium known in the art. An exemplary storage medium is coupled to the processor, such that the processor can read information from the storage medium and write information to the storage medium. The storage medium may also be a part of the processor. The processor and the storage medium may be located in an ASIC. In addition, the ASIC may be located in an access-network device, a target network device, or a core-network device. The processor and the storage medium may also exist in the access-network device, the target network device, or the core-network device as discrete components.

Those skilled in the art should appreciate that, in one or more of the foregoing examples, all or some of the functions described in embodiments of the disclosure may be implemented by software, hardware, firmware, or any other combination thereof. When implemented by software, all or some of the functions may be implemented in the form of a computer program product. The computer program product includes one or more computer instructions. When the computer program instructions are applied and executed on a computer, all or some of the procedures or functions described in embodiments of the disclosure are performed. The computer may be a general-purpose computer, a special-purpose computer, a computer network, or other programmable apparatuses. The computer instruction may be stored in a computer-readable storage medium, or transmitted from one computer-readable storage medium to another computer-readable storage medium. For example, the computer instruction may be transmitted from one website, computer, server, or data center to another website, computer, server, or data center in a wired manner (such as a coaxial cable, an optical fiber, a digital subscriber line (DSL), etc.) or in a wireless manner (such as infrared, wireless, microwave, etc.). The computer-readable storage medium may be any computer accessible usable-medium or a data storage device such as a server, a data center, or the like which integrates one or more usable media. The usable medium may be a magnetic medium (such as a soft disk, a hard disk, or a magnetic tape), an optical medium (such as a digital video disc (DVD)), or a semiconductor medium (such as a solid state disk (SSD)), etc.

The objectives, technical solutions, and advantages of embodiments of the disclosure are described in detail in the foregoing implementations. It should be understood that, the foregoing elaborations are merely implementations of the embodiments of the disclosure, and are not intended to limit the protection scope of the embodiments of the disclosure. Any modifications, equivalent replacements, improvements, and the like made based on the technical solutions of the embodiments of the disclosure shall all fall within the protection scope of the embodiments of the disclosure.

1. A method for reducing signal interference, applied to a wireless fidelity (Wi-Fi) circuitry of an electronic device and comprising:
sending session establishment request information to a new radio (NR) circuitry;
receiving session establishment response information from the NR circuitry;
setting a working state of the Wi-Fi circuitry to a first state, in response to determining, according to the session establishment response information, that there is signal interference between the Wi-Fi circuitry and the NR circuitry, and a current state of the NR circuitry being an idle state, wherein the first state is used for indicating a signal transmission and reception mode of the Wi-Fi circuitry; and
adjusting the working state of the Wi-Fi circuitry to a second state from the first state, in case there is still signal interference between the Wi-Fi circuitry and the NR circuitry, and the current state of the NR circuitry is a connected state, wherein the second state is used for indicating a signal transmission and reception mode of the Wi-Fi circuitry.

2. The method of claim 1, wherein setting the working state of the Wi-Fi circuitry to the first state comprises:
determining whether the NR circuitry has started random access; and
in case the NR circuitry has started random access, stopping signal transmission and reception of the Wi-Fi circuitry;
in case the NR circuitry has not started random access, performing signal transmission and reception of the Wi-Fi circuitry, and executing a first strategy.

3. The method of claim 2, wherein executing the first strategy comprises:
determining a downlink power of the NR circuitry;
determining a power back-off level according to the downlink power; and
performing power back-off according to the power back-off level, to reduce a transmit power of the Wi-Fi circuitry.

4. The method of claim 3, wherein the power back-off level comprises three levels, which comprise 6 decibels (dB) back-off, 12 dB back-off, and 18 dB back-off.

5. The method of claim 2, wherein setting the working state of the Wi-Fi circuitry to the first state comprises:
stopping signal transmission and reception of the Wi-Fi circuitry in response to the NR circuitry being receiving a system information block (SIB).

6. The method of claim 2, wherein in response to the NR circuitry being discontinuous reception (DRX)-enabled, setting the working state of the Wi-Fi circuitry to the first state comprises:
performing signal transmission and reception of the Wi-Fi circuitry in response to the NR circuitry being not receiving channel information;
stopping signal transmission and reception of the Wi-Fi circuitry in response to the NR circuitry being receiving channel information.

7. The method of any of claims 1 to 6, wherein the adjusting the working state of the Wi-Fi circuitry to the second state from the first state comprises:
obtaining a DRX state of the NR circuitry; and
executing a second strategy in response to the DRX state being a wake-up state;
executing a third strategy in response to the DRX state being a sleep state.

8. The method of claim 7, wherein before adjusting the working state of the Wi-Fi circuitry to the second state from the first state, the method further comprises:
sending slot pattern request information to the NR circuitry;
receiving slot pattern response information from the NR circuitry; and
determining a time domain corresponding to a downlink subframe and a special subframe according to the slot pattern response information.

9. The method of claim 8, wherein the second strategy comprises:
performing transmission and reception in the time domain corresponding to the downlink subframe and the special subframe.

10. The method of claim 9, wherein performing transmission and reception in the time domain corresponding to the downlink subframe and the special subframe comprises:
performing transmission and reception in the time domain corresponding to the downlink subframe and the special subframe and reducing the transmit power of the Wi-Fi circuitry.

11. The method of claim 7, wherein after executing the second strategy or executing the third strategy, the method further comprises:
obtaining a current service of the NR circuitry; and
stopping signal transmission and reception of the Wi-Fi circuitry in response to the current service being a voice service.

12. The method of any of claims 8 to 11, wherein after adjusting the working state of the Wi-Fi circuitry to the second state from the first state, the method further comprises:
obtaining the current state of the NR circuitry; and
adjusting the working state to the first state from the second state in response to the current state being the idle state.

13. The method of claim 1, wherein after setting the working state of the Wi-Fi circuitry to the first state or adjusting the working state to the second state from the first state, the method further comprises:
obtaining band information of each of the Wi-Fi circuitry and the NR circuitry;
adjusting the working state of the Wi-Fi circuitry to a third state from the first state or the second state in response to determining, according to the band information, that there is no interference between a Wi-Fi signal and an NR signal; or
adjusting the working state of the Wi-Fi circuitry to the third state from the first state or the second state after the Wi-Fi circuitry is disconnected.

14. A method for reducing signal interference, applied to a new radio (NR) circuitry of an electronic device and comprising:
obtaining session establishment request information from a wireless fidelity (Wi-Fi) circuitry; and
sending session establishment response information.

15. The method of claim 14, wherein after sending the session establishment response, the method further comprises:
sending frequency request information to the Wi-Fi circuitry;
obtaining frequency information from the Wi-Fi circuitry; and
reducing a transmit power of the NR circuitry in response to determining, according to the frequency information, that an operating band of the Wi-Fi circuitry overlaps an operating band of the NR circuitry.

16-17. (canceled)

18. An electronic device, comprising a wireless fidelity (Wi-Fi) circuitry, a processor, a memory storing one or more programs, wherein the one or more programs are configured to be executed by the processor to:
cause the Wi-Fi circuitry to send session establishment request information to a new radio (NR) circuitry;
cause the Wi-Fi circuitry to receive session establishment response information from the NR circuitry;
set a working state of the Wi-Fi circuitry to a first state, in response to determining, according to the session establishment response information, that there is signal interference between the Wi-Fi circuitry and the NR circuitry, and a current state of the NR circuitry being an idle state, wherein the first state is used for indicating a signal transmission and reception mode of the Wi-Fi circuitry; and
adjust the working state of the Wi-Fi circuitry to a second state from the first state, in case there is still signal interference between the Wi-Fi circuitry and the NR circuitry, and the current state of the NR circuitry is a connected state, wherein the second state is used for indicating a signal transmission and reception mode of the Wi-Fi circuitry.

19-20. (canceled)

21. The electronic device of claim 18, wherein the processor configured to set the working state of the Wi-Fi circuitry to the first state is configured to:
determine whether the NR circuitry has started random access; and
in case the NR circuitry has started random access, stop signal transmission and reception of the Wi-Fi circuitry;
in case the NR circuitry has not started random access, perform signal transmission and reception of the Wi-Fi circuitry, and execute a first strategy.

22. The electronic device of claim 21, wherein the processor configured to execute the first strategy is configured to:
determine a downlink power of the NR circuitry;
determine a power back-off level according to the downlink power; and
perform power back-off according to the power back-off level, to reduce a transmit power of the Wi-Fi circuitry.

23. The electronic device of claim 22, wherein the power back-off level comprises three levels, which comprise 6 decibels (dB) back-off, 12 dB back-off, and 18 dB back-off.

24. The electronic device of claim 21, wherein the processor configured to set the working state of the Wi-Fi circuitry to the first state is configured to:
stop signal transmission and reception of the Wi-Fi circuitry in response to the NR circuitry being receiving a system information block (SIB).
